(19) United States
(12) Patent Application Publication
(10) Pub. No.: US 2025/0045198 A1
(43) Pub. Date: Feb. 6, 2025

(54) ACCELERATING COMMAND LATENCIES USING A HYBRID COMPUTE EXPRESS LINK TYPE-3 SSD MEMORY DEVICE

(71) Applicant: Micron Technology, Inc., Boise, ID (US)

(72) Inventors: Rohit SEHGAL, San Jose, CA (US); Vishal TANNA, Santa Clara, CA (US); Eishan MIRAKHUR, Santa Clara, CA (US); Satheesh Babu MUTHUPANDI, Pleasanton, CA (US); Rajinikanth PANDURANGAN, Boise, ID (US)

(73) Assignee: Micron Technology, Inc., Boise, ID (US)

(21) Appl. No.: 18/678,973

(22) Filed: May 30, 2024

Related U.S. Application Data
(60) Provisional application No. 63/517,328, filed on Aug. 2, 2023.

(51) Int. Cl. G06F 12/02

(52) U.S. Cl. CPC G06F 12/0246

(57) ABSTRACT

Provided is a memory device, a method and a system that includes a host in communication with a system memory having a driver that creates commands for writing and reading data, and the memory device in communication with the host that includes a memory array including a plurality of memory components, a device attached memory including a submission queue and a completion queue for receiving commands from the driver, and a device controller configure to communicate with the device attached memory, the host and the plurality of memory components, such that the device controller receives an interface or link from the driver indicative of commands being placed into the submission queue, and automatically executes any pending commands therein for completion.

### CROSS-REFERENCE TO RELATED APPLICATION

This application claims benefit to U.S. Provisional Patent Application No. 63/517,328, filed Aug. 2, 2023, the disclosure is incorporated herein by reference in its entirety.

### TECHNICAL FIELD

The present disclosure relates generally to memory system and methods, and more particularly to a hybrid CXL Type-3 solid state (SSD) memory device and accelerating command latencies.

### BACKGROUND

Memory devices (also referred to as “memory media devices”) are widely used to store information in various electronic devices such as computers, user devices, wireless communication devices, cameras, digital displays, and the like. The memory devices typically include volatile or non-volatile memory. A non-volatile memory e.g., a flash memory allows information to be stored even when the non-volatile memory is not connected to a power source.

The memory devices are used to store data provided by a host (e.g., a computer) including a central processing unit (CPU) in communication with a system memory (e.g., a dynamic random-access memory (DRAM)) to store and retrieve data as well as instructions where the data is read back to the host. The instructions can include operating systems, drivers, and application programs. A driver operates and controls particular types of devices. Operating systems use the driver to offer resources and services provided by the devices.

A non-volatile memory specification is sometimes utilized i.e., a non-volatile memory express (NVMe) type specification which specifies the logical device interface protocol for accessing non-volatile memory by a peripheral component interconnect express (PCIe) bus via the host device. Typically, an NVMe based protocol works by utilizing submission queues (SQs) and completion queues (CQs) for submitting NVMe commands to a memory device and obtaining a notification of command completion through CQs. The SQs and CQs are currently allotted in the system memory with the assistance of an NVMe driver.

The host writes submission queues (i.e., input/output (I/O) command queues) and raises a doorbell (i.e., I/O command ready signals) and the NVMe controller of the memory device picks up the I/O command queues from the system memory, execute them and sends I/O completion queues. The host records the I/O completion queues and clears the doorbell with an I/O command completion signal. Therefore, this conventional process requires the memory device to hop to the system memory to retrieve the commands, thereby causing undesirable command latencies.

It is desirable to have a driver for creating submission queues and completion queues in a local device attached memory of a hybrid Compute Express Link (CXL) Type 3 SSD memory device which is memory-mapped to the host, for accessing and executing commands more quickly, thereby accelerating command latencies.

### DESCRIPTION OF THE DRAWINGS

FIG. 1 is a block diagram illustrating a system including a host and a hybrid memory device according to one or more exemplary embodiments of the present disclosure.

FIG. 2 is a flow diagram illustrating example method for NVMe write operations of the system of FIG. 1, according to one or more exemplary embodiments of the present disclosure.

FIG. 3 is a flow diagram illustrating example method for NVMe read operations of the system of FIG. 1, according to one or more exemplary embodiments of the present disclosure.

FIG. 4 is a flow diagram illustrating example method for CXL memory write/read operations of the system of FIG. 1, according to one or more exemplary embodiments of the present disclosure.

The drawings are only for purposes of illustrating preferred embodiments and are not to be construed as limiting the disclosure. Given the following enabling description of the drawings, the novel aspects of the presently described technology should become evident to a person of ordinary skill in the art. This detailed description uses numerical and letter designations to refer to features in the drawings. Like or similar designations in the drawings and description have been used to refer to like or similar parts of embodiments of the presently described technology.

### DETAILED DESCRIPTION OF THE EMBODIMENTS

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention implement a NVMe based protocol and improve the performances of the NVMe SSDs by utilizing a CXL type 3 device having a local device attached memory (DAM) wherein SQs and CQs are disposed on the device attached memory instead of the system memory on a system platform or host. This ensures that whenever the host is submitting the NVMe commands; these commands are already present locally inside the device attached memory which is memory-mapped to the host.

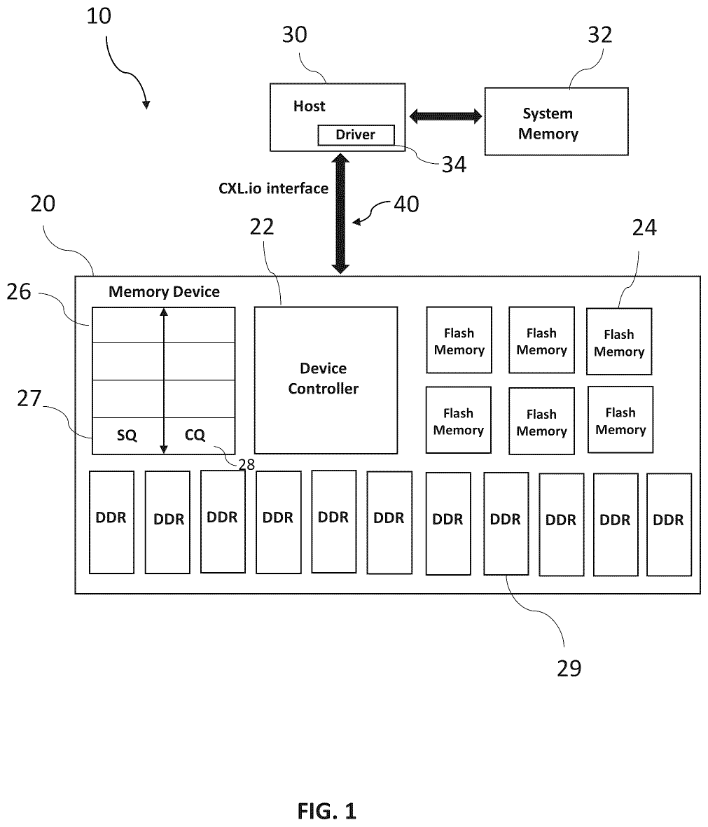

FIG. 1 is a block diagram illustrating a system 10. The system 10 includes a memory device 20 interfacing with a host 30 (e.g., a computer) having a system memory 32 e.g., a DRAM for storing data and instructions and a driver 34. The host 30 and the system memory 32 may or may not be physically co-located. The host 30 may be located remotely from the system memory 32 or they may be integrated.

The host 30 can be a host system including for example, a personal laptop computer, a desktop computer, a mobile device (e.g., a cellular phone), a network servicer, a memory card reader, a camera or any other suitable type of host system or device.

According to embodiments of the present disclosure, the memory device 20 is a single hybrid CXL type 3 SSD that includes a device controller 22, a memory array including a plurality of memory components (e.g., flash memory devices 24) integrated therein, a local device attached memory (DAM) 26 and a plurality of memory devices 29 (e.g., double date rate (DDR) memory).

As shown, the host 30 is in communication with the system memory 32 and the memory device 20, to transmit and receive data therebetween. The driver 34 is configured to create submission queue(s) (SQ) 27 and completion queue(s) (CQ) 28 and to transmit data to and from the device attached memory 26.

The driver 34 is an NVMe driver configured to create NVMe commands to be sent to the memory device 20 via a PCIe bus using a CXL.io interface or link 40. There are two different types of memory protocols (CXL.io and CXL.mem).

The device controller 22 comprises a hybrid CXL/NVMe device controller and is configured to distinguish between CXL.io, CXL.mem and NVMe packets wrapped in CXL.io packets. It can then process the packets accordingly. For example, the device controller 22 is configured to determine when a CXL.io packet is being transmitted thereto, and whether an NVMe packet is inside of the CXL.io packet.

If the device controller 22 makes that determination that an NVMe packet is present, it will take out that information and act upon it by sending a message to the submission queue 27. However, if it determines that it is strictly a CXL.io packet it will process it accordingly, and if it is a CXL.mem packet, then the device controller 22 will transmit the data into a DDR memory device 29 of the memory device 20 which is already memory-mapped to the host 30. According to an embodiment of the present disclosure, the device controller 22 and its components may be implemented in hardware, firmware and software, or any combinations thereof.

Further shown in FIG. 1, the flash memory devices 24 may comprise NAND flash non-volatile memory, a persistent byte-addressable memory, a NOR flash non-volatile memory or any persistent memory thereof or other suitable memory for the purpose set forth herein. The flash memory devices 24 retrieve and store data therein.

The memory devices 29 may comprise DDR DRAM devices such as DDR5, or any other persistent byte-addressable memory, or byte-addressable volatile or non-volatile memory or any other suitable memory devices for the purpose set forth herein.

The local device attached memory 26 is memory-mapped to the host 30 such that the host 30 can use the device attached memory 26 to create NVMe submission queues 27 and completion queues 28 therein.

Embodiments of the present disclosure implement a producer-consumer model, wherein the host 30 populates, via the driver 34, the I/O requests (.NVMe read/write commands) per CPU core and raises a doorbell by placing these commands inside a submission queue 27 disposed locally in the device attached memory 26 of the memory device 20; and the memory device 20 consumes any pending commands automatically in the submission queue 27.

According to embodiments, There is one submission queue 27 and corresponding completion queue 28 per CPU core. For example, for a 128 core CPU, there will be 128 SQ/CQ pairs inside the device attached memory 26. According to embodiments each of these submission queues 27, completion queues 28 is a circular buffer space that is created by the driver 34 in the device attached memory 26, via the device controller 22 during device enumeration. In some embodiments, the driver 34, for example, may generate up to 64,000 queues and up to 64,000 NVME commands per queue.

After a command is completed, it is placed in a completion queue 28 in the device attached memory 26, and then the device controller 22 instructs the buffer space utilized for the command to be cleared. Internal controller logic of the device controller 22 monitors and polls the submission queue 27 in the device attached memory 26 to ensure that all commands are acted upon immediately and consumed, thereby accelerating command latencies existing in conventional memory systems.

In order to minimize the latencies, it is necessary for the application data that needs to be stored on the flash memory, to reside inside the DDR memory device 29 (e.g., DDR5) of the memory device 20. Secondly, in comparison to the conventional processes where the SQ/CQ were present on the system memory 32 (e.g., DRAM), in the present disclosure when a NVME command is submitted to the device attached memory 26, the device controller 22 can quickly access the local, device attached memory 26 and pick up the NVME command rather than perform a DMA access to the system memory.

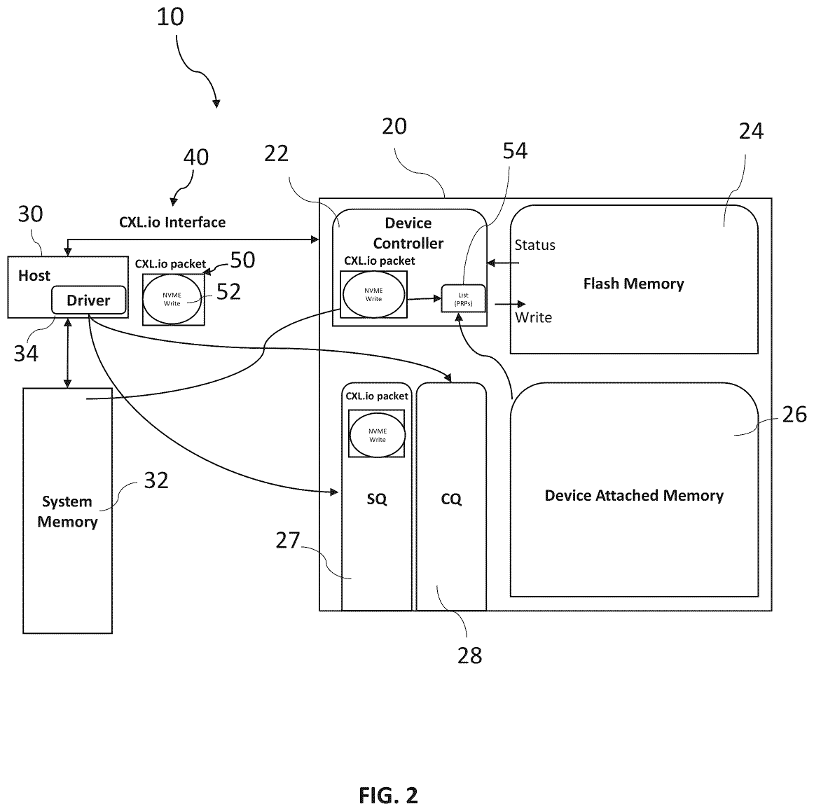

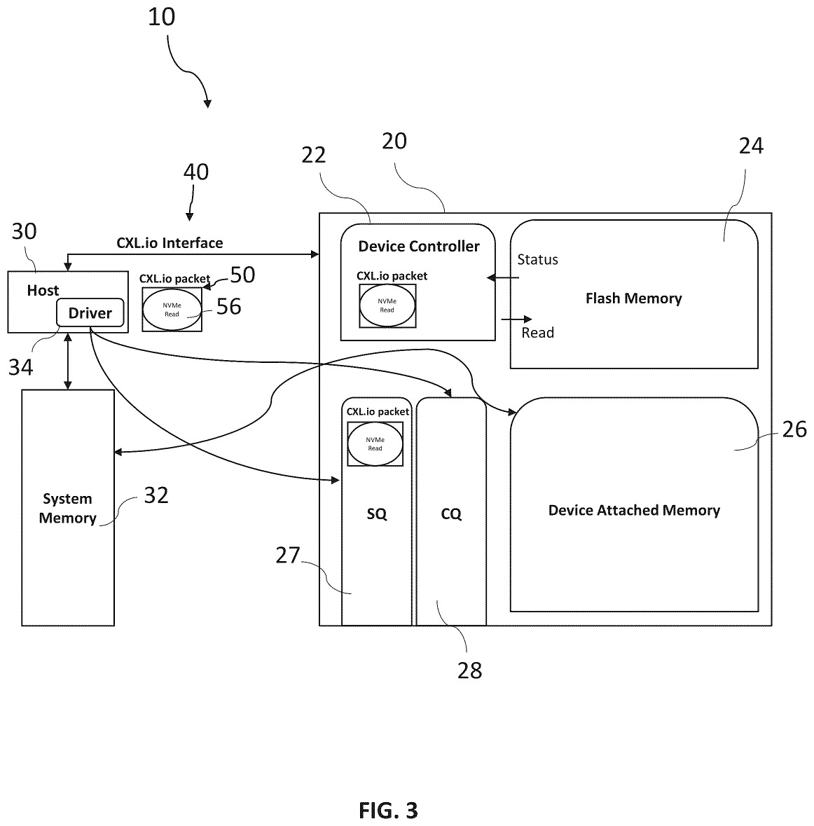

Write and read operations of the memory device 20 according to one or more embodiments of the present disclosure will now be described below with reference to FIGS. 2 and 3.

FIG. 2 is a flow diagram illustrating an example method for NVMe write operations of the system of FIG. 1. As shown in FIG. 2, the host 30 includes the driver 34 and communicates with the memory device 20 via a CXL interface or link 40 over a bus e.g., a Peripheral component interconnect express (PCLe) Gen5.

As mentioned, the driver 34 is responsible for the creation of submission queues 27 and completion queues 28 and movement of data to and from the device attached memory 26 of the memory device 20.

In operation, a NVME write command 52 wrapped inside a CXL.io packet 50 is submitted by the host 30 into the submission queue 27 of the device attached memory 26 via the driver 34. That is, the driver 34 utilizes the submission queues 27 and completion queues 28 in the device attached memory 26 of the memory device 20 to submit the NVMe commands.

It is to be noted that the data to be written to the flash memory device 24 can be present in the device attached memory 26 (e.g., CXL Type 3 device) or it can be present in the system memory 32 (e.g., DRAM) based on the application's memory assignment.

The driver 34 is configured to prepare the NVMe command 52 (e.g., a NVMe write command) and the scatter-gather list with physical region pages (PRPs) 54 to be able to complete the write of data from the memory (e.g., the device attached memory 26 or the system memory 32) into the flash memory device 24. In some cases, there is the presence of all data to be written to the flash memory device 24 to be present in the device attached memory 26. And in other cases, the data can also be present in the system memory 32 (e.g., a DRAM).

According to embodiments of the present disclosure, the memory device 20 is aware of the address ranges that are available locally in the device attached memory 26 and the address ranges that are in the system memory 32. This information is advertised by the memory device 20 to the host 30 and the driver 34 during device enumeration via PCIe having Designated vendor specific extended capability (DVSEC). This provides the address ranges for the device attached memory 26 and the DDR memory device 29 to the host 30 and the driver 34. This information can be passed to the device attached memory 26.

As noted above, the device controller 22 is configured to determine if the CXL.io packet 50 includes a NVMe write command 52 The driver 34 sends the write command 52 wrapped inside a CXL.io packet 50 to the submission queue 27. The device controller 22 is also configured to monitor and identify the presence of any new commands on the submission queue 27 and start to load/execute on those commands automatically. That is, the device controller 22 is configured to poll for any new entries in the submission queues 27 and knows as soon as an entry exists and picks up the new command. Alternatively, according to embodiments, when an entry is made to a submission queue 27, the driver 34 can raise a doorbell to the device controller 22 to pick up the entry from the submission queue 27 and start processing it. The command is then processed by the device controller 22 and depending whether it is a write command 52 or read command 56 it will follow the process shown in FIG. 2 or 3, respectively.

All the commands submitted by the driver 34 are first processed by the device controller 22. The front-end interface logic of the device controller 22 then determines if the CXL.io packet has an NVME wrapped inside it. If so, then the device controller 22 will forward the command directly into the submission queue 27 of the device attached memory.

The data is then written to the flash memory device 24 (e.g., NOT-And (NAND) flash storage) from the system memory 32 or the device attached memory 26. The status of completion of this write command 52 is then sent to the device controller 22 and the device controller 22 then instructs the write command 52 to be moved to the completion queue 28 and the buffer space associated with the write command 52 to be cleared. The driver 34 is able to access the completion queue to determine the status of completion of the write command 52.

FIG. 3 is a flow diagram illustrating an example method for NVMe read operations of the system of FIG. 1 according to one or more exemplary embodiments of the present disclosure. As shown, similarly to the write operation of FIG. 2, in the read operation shown in FIG. 3, the driver 34 prepares the CXL.io packet 50 with an NVMe read command 56 therein and transfers it to the submission queue 27 of the memory device 20. The device controller 22 also identifies the NVMe read command 56 in the submission queue 27.

The device controller 22 then polls a logical-to-physical (L2P) mapping table stored which associates each data with a logical address. The L2P mapping table stores the mapping of logical addresses to physical addresses indicated location of the data stored in flash memory device 24. The device attached memory 26 moves the data corresponding to the read command 56 into the device attached memory 26 which can then be accessed by the host 30.

Since the device attached memory 26 is memory-mapped to the host 30, the host 30 can directly read the data from the device attached memory 26. Thus, no direct memory access (DMA) transfers are required to the system memory 32 if the SQ/CQ exists in the RAM instead of the device attached memory 26. Once the data is read, the status of the read command 56 is retrieved by the device controller 22 and the read command 56 is then placed in the completion queue 28.

The present disclosure provides the benefits of the data buffers for the write commands 52 and read commands 56 being created on the device attached memory that is local to memory device 20. For example, since the read command 56 is put into a command (a submission queue 27 or completion queue 28) the memory device 20 will also create the data buffers for the read command 56. Thus, in the present disclosure, everything is created on the local device attached memory and informs the host 30 when the commands are completed. The host 30 may still read the data from the device attached memory 26 via the load store transactions.

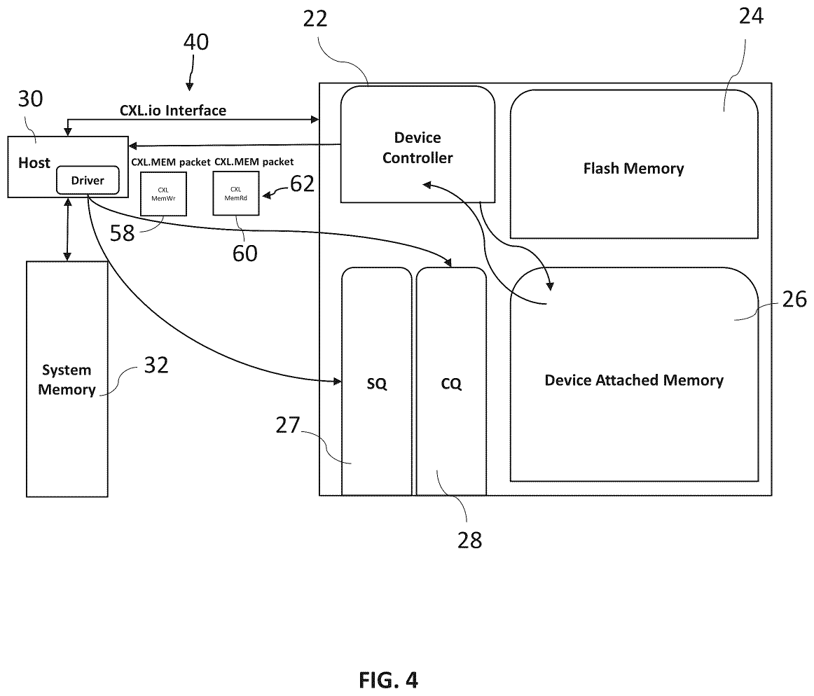

FIG. 4 is a flow diagram illustrating an example method for CXL memory write/read operations of the system of FIG. 1, according to one or more exemplary embodiments of the present disclosure. As shown, existing data can also be processed directly between the host 30 and the device attached memory 26 via CXL memory write and read commands 58 and 60. The driver 34 sends the CXL memory write command 58 or memory read command 60 of a CXL.mem packet 62 to the device controller 22 and the device controller 22 processes the CXL write or read command 58 or 60 associated data requested as part of the load/store it directly goes to the corresponding address on the DDR memory device 29, retrieves or writes the data and if retrieved then sends the data back to the host 30. Thus, the data is either written or read from the DDR memory device 29.

A number of embodiments of the present disclosure provide benefits such a single hybrid device which can function as a CXL Type 3 device and as a SSD device, resulting in an improved optimized SSD having less command latencies and being more cost-effective capable of working both as a SSD and a memory expander or an accelerator.

Although specific embodiments have been illustrated and described herein, those of ordinary skill in the art will appreciate that an arrangement calculated to achieve the same results can be substituted for the specific embodiments shown. This disclosure is intended to cover adaptations or variations of a number of embodiments of the present disclosure. It is to be understood that the above description has been made in an illustrative fashion, and not a restrictive one.

Combination of the above embodiments, and other embodiments not specifically described herein will be apparent to those of ordinary skill in the art upon reviewing the above description. The scope of a number of embodiments of the present disclosure includes other applications in which the above structures and methods are used. Therefore, the scope of a number of embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a host in communication with a system memory and comprising a driver configured to create commands for writing and reading data; and
a memory device in communication with the host, and configured to store data therein, the memory device comprising:
a memory array including a plurality of memory components for storing memory therein,
device attached memory comprising a submission queue and a completion queue for receiving commands from the driver, and
a device controller configured to communicate with the device attached memory, the host, and the plurality of memory components, wherein the device controller receives an interface or link from the driver indicative of commands being placed into the submission queue, and automatically executes any pending commands therein for completion.

2. The system of claim 1, wherein the device attached memory is memory-mapped to the host.

3. The system of claim 1, wherein the driver includes a non-volatile memory express (NVMe) type driver and is configured to create NVMe commands.

4. The system of claim 3, wherein the device controller comprises a hybrid compute express link (CXL)/NVMe device controller, wherein the device controller is configured to determine a type of CXL packet and NVMe command wrapped inside the CXL packet received via the interface or link from the driver.

5. The system of claim 4, wherein the memory device is a CXL Type 3 solid state memory device and the plurality of memory components each comprise flash memory.

6. The system of claim 5, wherein upon creation of the NVMe commands via the driver, the host is configured to raise a doorbell by placing the NVMe commands inside the submission queue at the device attached memory and the memory device consumes any pending commands automatically therein.

7. The system of claim 6, wherein once a respective NVMe command is completed, the device controller is configured to move the completed NVMe command to be placed in the completion queue in the device attached memory, and then instruct a buffer space utilized for the respective NVMe command to be cleared.

8. The system of claim 5, wherein when the NVMe command comprises a write command, the device controller is configured to confirm if the packet received at the submission queue includes the write command and, and the device controller then starts to execute the write command automatically wherein associated data is written to a memory component of the plurality of memory components.

9. The system of claim 8, wherein a status of completion of the write command is sent to the device controller and the device controller is configured to instruct the write command to be moved to the completion queue and the buffer space occupied thereby to be cleared.

10. The system of claim 5, wherein when the NVMe is a read command, the driver is configured to prepare the packet with the read command therein and to transfer the read command to the submission queue, and the device controller is configured to identify the read command in the submission queue and poll a logical-to-physical (L2P) mapping table to determine a location of the data to be read as stored a memory component of the plurality of memory components. The device attached memory is then configured to move the data corresponding to the read command into the device attached memory 26 which can then be accessed by the host.

11. The system of claim 10, wherein once the data is read, a status of the read command is retrieved by the device controller and the read command is then placed in the completion queue.

12. A method for performing write operations of data in a memory device comprising a device attached memory, a device controller and a plurality of memory components, the method comprising:
creating, via a driver of a host, commands for writing and reading data
receiving at the device attached memory the commands in a submission queue;
communicating, via the device controller, with the device attached memory, the host and a plurality of memory components including receiving via the device controller, an interface or link from the driver indicative of commands being placed into the submission queue, and automatically executing any pending commands therein for completion.

13. The method of claim 12, wherein the device attached memory is memory-mapped to the host and the driver includes a non-volatile memory express (NVMe) type driver and is configured for creating NVMe commands.

14. The method of claim 13, wherein, wherein the device controller comprises hybrid compute express link (CXL)/NVMe device controller, the method further comprises: determining a type of CXL packet and NVMe command wrapped inside the CXL packet, received via the interface or link from the driver.

15. The method of claim 14, wherein upon creation of the NVMe commands via the driver, the method further comprises:
raising a doorbell for the device controller via the driver at the host, by placing the NVMe commands inside the submission queue at the device attached memory and consuming any pending commands automatically therein via the device controller.

16. The method of claim 15, wherein once a respective NVMe command is completed, the method further comprises:
moving, via the device controller the completed NVMe command into a completion queue in the device attached memory, and then instructing a buffer space utilized for the respective NVMe command to be cleared.

17. The method of claim 15, wherein when the NVMe command comprises a write command, the method further comprises:
confirming, via the device controller if the packet received at the submission queue includes the write command; and
executing the write command automatically wherein associated data is written to a memory component of the plurality of memory components.

18. The method of claim 17, wherein the method further comprises:
sending a status of completion of the write command to the device controller; and
instructing, via the device controller, the write command to be moved to a completion queue of the device attached memory and the buffer space occupied thereby to be cleared.

19. The method of claim 15, wherein when the NVMe is a read command, the method further comprises:
preparing at the driver, the packet with the read command therein and transferring the read command to the submission queue;
identifying via the device controller the read command in the submission queue and polling a logical-to-physical (L2P) mapping table to determine a location of the data to be read as stored a memory component of the plurality of memory components; and
moving the data corresponding to the read command into the device attached memory to be accessed by the host.

20. The method of claim 19, wherein once the data is read, the method comprises: retrieving at the device controller, a status of the read command and placing the read command in a completion queue of the device attached memory.

21. A memory device in communication with a host including a driver for creating commands for writing and reading data, the memory device comprising:
a memory array including a plurality of memory components for storing memory therein,
device attached memory comprising a submission queue and a completion queue for receiving commands from the driver, and
a device controller configured to communicate with the device attached memory, the host, and the plurality of memory components, wherein the device controller receives an interface or link from the driver indicative of commands being placed into the submission queue, and automatically executes any pending commands therein for completion.
